(19) United States
(12) Patent Application Publication
(10) Pub. No.: US 2011/0202269 A1
(43) Pub. Date: Aug. 18, 2011

(54) MOBILE GAMING, HOSPITALITY AND COMMUNICATIONS APPLIANCE

(75) Inventor: Christian von Reventlow, Gladstone, NJ (US)

(73) Assignee: AVAYA INC., Basking Ridge, NJ (US)

(21) Appl. No.: 12/825,035

(22) Filed: Jun. 28, 2010

Related U.S. Application Data
(60) Provisional application No. 61/304,705, filed on Feb. 15, 2010.

(51) Int. Cl. G06F 9/46; A63F 9/24; G06F 15/16; G06F 21/00; G06F 3/048; G01C 21/00

(52) U.S. Cl. 701/201; 463/16; 719/328; 709/227; 726/3; 715/764

(57) ABSTRACT

Methods and systems provided herein provide a user device that is capable of offering its user an extraordinary experience while staying at a hospitality vendor. In particular, the user is allowed to interact with the user device and have access to a number of applications either stored on the user device or made accessible to the user device. Moreover, the applications made available to the user may be controlled, based on the device's location, the user's presence information, or both, to heighten the user experience and/or ensure compliance with applicable regulations.

### CROSS-REFERENCE TO RELATED APPLICATIONS

This application claims the benefit of U.S. Provisional Application No. 61/304,705, filed Feb. 15, 2010, the entire disclosure of which is hereby incorporated herein by reference.

### FIELD OF THE INVENTION

The present invention is generally directed toward communications and more specifically toward communication devices.

### BACKGROUND

Premium hospitality businesses (Resorts, Casinos, Spas, Cruise ships, Theme Parks, etc.) succeed or fail in direct correlation to how effectively they deliver a memorable and positive customer experience to their guests. The customer experience begins with the process for making a reservation and continues throughout the guest visit. Every experience including arrival, check-in, room assignment, food service, bar, exercise facilities, pool/spa, activities, excursions, retail stores, entertainment, checkout, departure, and the like must deliver a remarkable experience for a guest to consider booking another visit; and also to recommend the resort to friends and family. The ease of which customers can book and enjoy activities, upgrades, dining choices, make changes and the like is also key. The ability for a customer to participate in gaming/gambling during short durations of time not committed to other activities also represents a potentially large incremental revenue opportunity for the hospitality vendor.

The core of every remarkable customer experience at a premium hospitality business is for each guest to feel they are receiving personalized, convenient, and highly responsive service at all times. To achieve this standard, resorts generally must hire a large staff of people who are always ready to react to guest needs. However as resorts grow ever larger, and aim to serve much larger populations of guests, it becomes much more difficult to manage staffing to consistently deliver the remarkable guest experience. Guests in rooms have access to hotel telephones they can use to summon appropriate resort staff to deliver what they require while they are in their rooms. However, when guests are elsewhere on a large resort property, the access to a resort phone is significantly reduced. Even when a resort phone can be found there is no way for the resort staff to know, in advance of answering a call from that phone, which guest is calling. Without that information they cannot greet the guest by name, and thereby deliver a personalized experience. The standard experience for a guest looking for assistance while away from a room involves having to search out a resort staff-member and start asking for the help they need. Very often the staff member they find is not authorized or not trained to help and they must subsequently go looking for a staff-member who can help. This is a frustrating situation both for guests and staff. The traditional approach to this problem is for resorts to position extra staff in key areas to be ready to respond to any guest needs as they arise. This approach, however, is very expensive and usually highly inefficient. Despite the efforts to staff appropriately, there are numerous times when the resort either has too much staff or too little staff in place to meet guest's needs across large resort property. This problem is encountered throughout the hotel/resort industry and remains largely unsolved.

Environmental factors such as noise, temperature (from lights, gaming machines, sun or the like), smoke (cigarette, pipe, and cigars), foot traffic, and the like can cause certain rooms, locations or the like to be undesirable for certain guests to make use of (such as a smoky venue for a non-smoker). This makes it very difficult for the hospitality business to create an environment conducive for gaming/gambling or enjoyment of other facilities for all customers. There are also times when a customer is not involved in another activity where they might like to make use of gaming/gambling facilities but lack the time to walk through large facilities to make use of them. Still another problem is that customers may want to, or need to, be aware of multiple activities, communications and the like in near real-time. There are currently no solutions to this problem.

Another problem is that currently, most gaming devices are fixed location devices. While gaming/gambling laws allow mobile device gaming (See e.g., Nevada Gaming Regulations NRS463.014), there are a number of problems with the current art for such devices. One problem is that such mobile devices can only be used within a defined space. It would be advantageous to allow one device to work within any area that has legal gambling across a single hotel or between a number of physically separate but cooperatively owned or managed properties.

In addition, the current art issues a variety of keys, cards, devices, permissions and the like to the visitor of a premium hospitality property. Further, specialized kiosks, many with different user interfaces, are located throughout hospitality properties. It would be advantageous if these devices were mobile instead of having a fixed location. Integrating communications, reservations, billing and gaming/gambling allows a user to quickly, effectively and conveniently interact with the hospitality vendor via a single unified interface for everything except face to face gaming/gambling.

Premium hospitality properties have an enormous investment in fixed location gaming/gambling devices. There is an opportunity to duplicate many of the electronic games in the form of a portable device kiosk at a greatly reduced cost. In addition, many of the fixed location devices only function as a single game, requiring the customer to get up and move to play another game. Mobile gaming/gambling kiosks allow a plurality of different games to be loaded in the device and/or pushed from a centralized server, at the request of the customer via the device. However, current mobile kiosks (such as those from Omega Gaming) fail to solve any of the customer service issues described above, they fail to provide full multi-media communications capabilities, they fail to provide the ability to present multiple windows that each provide specific functionality and the like. Because a device with location awareness, communications capabilities and the full gamut of reservation options available from the hospitality vendor are not available, current devices fall well short of the desired customer experience described above.

Another problem is that even the most evolved hospitality applications currently available, such as those described in U.S. patent application Ser. No. 12/337,904, filed Dec. 18, 2008, are intended to be used in cooperation with a customer's existing cell phone or device. Due to gaming/gambling laws, customer devices are not permitted to be used as gaming/gambling mobile devices.

The prior art in regards to touch screen hospitality kiosks is limited to point of purchase specialized computers such as those offered by Tyco electronics and their ELO line. Such devices are really intended to be point of purchase, point of sale devices for a fixed location and do not integrate gaming/gambling or communications capabilities and they are not mobile and assigned to a specific customer.

The challenge then is to find a solution to the above stated problems that delivers a consistently remarkable guest experience, in large resort settings, while efficiently leveraging resort staff.

### SUMMARY

It is with respect to the above issues and other problems that the embodiments presented herein were contemplated. Embodiments of the present invention proposed herein are designed to solve this problem while limiting the number of cards, keys, devices, authorizations and the like down to the use of one specialized communications and gaming/gambling appliance.

At a very high level, what is proposed herein is a mobile, location aware, unified customer specific kiosk that allows communications, gaming/gambling, schedule management, and/or reservation/customer service capabilities as an application or alternatively as a touch screen device with such an application. More specifically, the notion presented herein attempts to solve the problems associated with reservation/customer service issues associated with a large and/or distributed hospitality environments. Further, it does so with the complete range of communications capabilities that a modern Private Branch eXchange (PBX) offers. Still further, it does so with fully integrated gaming/gambling capabilities. It also integrates historical preferences, security, location awareness, and other capabilities described in more detail below.

In order to provide these capabilities, a number of modules working together are proposed.

A first exemplary module is either an application for a ubiquitous touch screen device, such as an Apple iPhone or the like, or a proprietary touch screen device with such an application preloaded. A device that is optimized for complex communications, with location awareness via rich presence, geofencing, geopod technology, or the like is ideally suited for this purpose. Such a device that is designed to allow multiple contexts or user persona is also ideally suited to this purpose. Examples of such devices are discussed in further detail in U.S. patent application Ser. Nos. 12/240,256 and 12/561,459 filed Sep. 29, 2008, and Sep. 17, 2009, respectively, both of which are hereby incorporated herein by reference in their entirety.

In addition, a unified communications system can be used advantageously for both communications within the hospitality environment for obtaining reservations and customer service as well as providing the accounting, billing and right of way for external communications. These services can consider the identity of the user, their authorization, access, special status, location, and the like in providing specialized communications services. For example, a real-time video session with a customer service agent may be available for a preferred customer whereas the hospitality vendor might dispatch the nearest employee if a VIP needs help. In addition, the unified communications system can integrate with one or more of the other modules described below.

Another exemplary module proposed herein is a presence awareness module which would be enabled to make use of rich presence, geofencing, geopods, or the like to establish where the user is located. This would allow location-based services such as gaming/gambling, specialized direction capabilities such as hospitality maps from their current location to the location that the customer is trying to locate, virtual waiting in line capabilities that summon the user when their position in line is ready for service and many other similar capabilities.

Another exemplary module proposed herein is a hospitality module which would be enabled to make use of the identity of the user, their preferences, account, room, access, special status or permissions, credits, vouchers, and the like to offer a complete menu of the services, reservations, capabilities, concierge, and the like offered by the hospitality vendor. It would allow specialized queries, the ability to lock, unlock, or check on the status of a room. It would provide all of the other improvements as are taught by U.S. patent application Ser. No. 12/337,904, filed Dec. 18, 2008, the entire contents of which are hereby incorporated herein by reference, but integrated with the other capabilities described herein with a proprietary application and/or device.

Another exemplary module proposed herein is a gaming/gambling module which would be enabled to make use of electronic forms of many of the same games available on a casino floor. It provides location awareness to enforce limitations with regard to location that local and regional gambling laws may require. It may also provide for tamper sensing, auditing by gambling authorities and other such features required by applicable gaming/gambling regulations. It provides these services with an awareness of a specific user's identity, preferences, limits, current bills, and the like. It would allow games to be suspended to make use of the communications, location, and hospitality modules, and any other modules described herein.

Another exemplary module proposed herein is a security module which would be enabled to allow for transactional security such as credit, debit, or specialized lines of credit such as in the case of a casino. It may be configured to allow a variety of authentication mechanisms to protect the user should they loose their specialized device. It may also be configured to act as the gatekeeper with regard to special access or permission capabilities within the hospitality environment. It may also be configured to detect when the device appears to be at a different location than the authorized user (i.e., when the presence information for a user does not match the location information for the device) and could inactivate the device and warn the hospitality vendor.

Another exemplary module proposed herein is a news feed module which would be enabled to provide sports scores, major news, specialized time-sensitive discount opportunities, and other such bulletins that the user may want to subscribe to. It may be configured to allow storage of profiles for such information so that during a subsequent visit, that the feeds would not need to be set-up again or could be modified from this starting point. The module could be tailored via the user's preferences to present the information as an IM, email or other type of notification. This module could also be configured to warn a user of a public safety notice such as a fire drill, building alarm, severe weather warning or the like.

Another exemplary module proposed herein is a personal profile module which would be enabled to allow a record of prior visits, the customer/user preferences, events/activities/comments, and the like to be stored and referenced during a subsequent visit. This allows the customer to repeat activities that they enjoyed, cover portions of the hospitality environment not previously visited, show a virtual tour of areas of the hospitality environment not yet visited and the like. It could also be configured to provide a record of expenses on previous trips versus current expenses to allow the customer to manage the cost of their stay.

Another exemplary module proposed herein is a scheduling module which would be enabled to allow the user to set-up and manage their schedule while a guest of the hospitality vendor. Reservations would automatically populate into the scheduling module. Daily agendas could be printed out or accessed via the application and/or specialized device. Warnings could be issued based on input from the location aware module if the user's current location and direction would potentially limit their ability to attend pre-reserved activities. Reminders could be issued to notify the user that they need to leave for a reservation and the location aware module could provide the most efficient path the reserved activity or facility.

One or more of the above-described modules and other exemplary modules described herein may be provided on or made accessible to a single communication device in accordance with at least some embodiments of the present invention.

Because additional utility to the customer of a hospitality vendor are provided uniquely by the combination of the modules, and because they are made available through a single device or application, rather than a variety of devices and applications each with a different user interface, a significant improvement over the current art is provided. The improvements possible with the notions presented in the present disclosure offer real advantages to both the customer and the proprietor of the hospitality business. This can result in both increased revenue for the vendor and increased customer satisfaction for the customer.

Some examples of unique capabilities for such a system include, but are not limited to, the ability to:

1) Stand in line for an event or service virtually via their device in a queue that considers the date/time, the customer's current location and time needed to get to the event or service, and the status of customers being served in front of you in the virtual queue;

2) Make reservations, access customer service or a variety of other hospitality interactions while simultaneously enjoying gaming/gambling or other activities such as a show, event or the like;

3) Communicate with other parties internal and/or external to the hospitality environment and suspending gaming/gambling to participate in such communications;

4) Be warned when the current location and travel is likely to take the customer too far away to reach the location of other reservations on their calendar;

5) Make use of a temporary calendar or agenda tool to remind them of reservations including automatic population and schedule conflict capabilities;

6) Set up multiple windows on the device or application to allow viewing of a sports event simultaneously with mobile gaming virtually extending sports books beyond a specific venue;

7) Be notified of news, public service, special offers, and security information;

8) Monitor child care or other activities where the customer may have minors present;

9) Learn one user interface for all communications, transactions, reservations and the like with the hospitality vendor;

10) Store settings, favorites, comments, agenda and the like from previous visits leaving more time for enjoying the customer experience;

11) Remotely extend preferential capabilities/privileges to other members of an associated group or party based on your own authorized capabilities or privileges;

12) Remotely notify and coordinate activities among an associated group or party;

13) Display relative position and maps to meet among an associated group or party;

14) Move among associated hotels, casinos, facilities, partners and the like seamlessly and enjoy the same level of customer service using a single device;

15) Make preferential reservations, in the same manner as a good Concierge, based on your identity, hospitality vendor, and the like independent of whether the reservation is with a hospitality partner or not;

16) Be aware of other activities that are proximate to their current location that they may be interested in based on activities reserved and locations visited during their current (or any previous) stay at the hospitality vendor;

17) Make use of short idle periods between other events, activities or the like for gaming/gambling, virtual facility exploration or the like;

18) Coordinate hospitality events, activities, or the like, with a dissimilar schedule for a travel purpose such as a trade show, a group of meetings or the like;

19) Explore events, activities or the like that are available, fit certain preferences, and fit in a time interval that the customer is seeking to fill; and/or

20) Keep a record of what events, activities, or the like have been enjoyed during future visits with customer/user specific notes about how they enjoyed the event, activity or the like and whether they want to do it again on a subsequent visit.

As would be apparent to one skilled in the art, there are many other possible variations on this theme without departing from the capabilities of the solutions described herein.

In accordance with at least some embodiments of the present invention, a method is provided that generally comprises:

receiving a user input at the user device;

determining that the user input corresponds to a command for controlling an application or module via the user device;

prior to executing the command, referencing profile information containing one or more rules which govern a user's utilization of the user device;

receiving at least one of user presence information and user device location information; and

based on the profile information and the at least one of user presence information and user device location information, determining whether to one of (i) restrict the command prior to controlling the application or module and (ii) execute the command without restriction.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of a high-level communication system in accordance with embodiments of the present invention;

FIG. 2 is a block diagram depicting details of a communication system in accordance with embodiments of the present invention;

FIG. 3 is a block diagram depicting a user device in accordance with embodiments of the present invention;

FIG. 4 is a block diagram depicting an exemplary data structure utilized in accordance with embodiments of the present invention;

FIG. 5 is a flow diagram depicting an exemplary communication-application control method in accordance with embodiments of the present invention;

FIG. 6 is a flow diagram depicting a communication method in accordance with embodiments of the present invention;

FIG. 7 is a flow diagram depicting a hospitality method in accordance with embodiments of the present invention;

FIG. 8 is a flow diagram depicting a security method in accordance with embodiments of the present invention;

FIG. 9 is a flow diagram depicting a profile population method in accordance with embodiments of the present invention; and

FIG. 10 is a flow diagram depicting a scheduling method in accordance with embodiments of the present invention.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

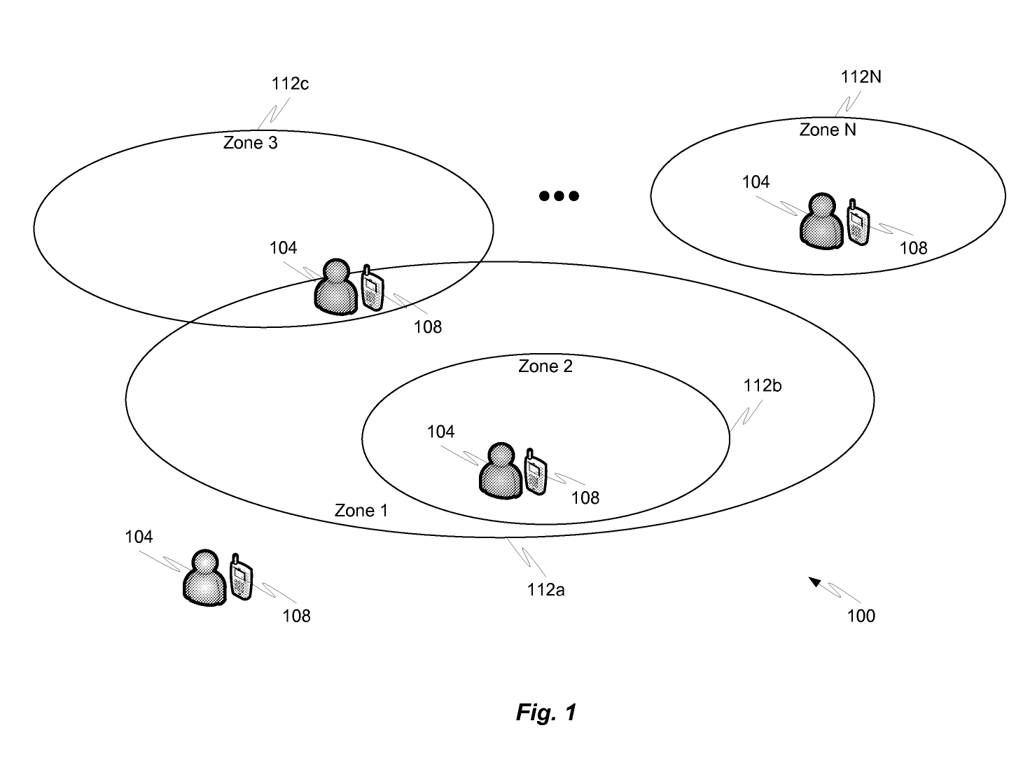

A communication system 100, for controlling communication sessions and user device functionality, is shown in FIG. 1. The communication system 100 can include one or more user(s) 104 utilizing a respective user device 108.

The user devices 108 can be any suitable circuit- or packet-switched or digital (e.g., TDM-enabled) communication device. Examples include wired and wireless telephones, Personal Digital Assistants (PDAs), Personal Computers or PCs, laptops, packet-based H.320 video phones and conferencing units, packet-based voice messaging and response units, peer-to-peer based communication devices, cellular phones, smartphones, packet-based traditional computer telephony adjuncts, and combinations thereof.

Some or all of the user devices 108 may have been distributed by a hospitality vendor to the user 104. In such a situation, the user device 108 may be considered leased to the user 104 for the duration of the user's 104 stay with the hospitality vendor. In some embodiments, some of the user devices 108 may be owned by the user 104. In some embodiments, some of the user devices 108 may be owned by different entities.

The communication system 100 may also comprise one or more zones 112a-N, which can be used to achieve a number of different objectives. For example, the zones 112a-N may be utilized to automatically control communication capabilities of the user device 108. As another example, the zones 112a-N may be utilized to automatically control functionality of the user device 108. As another example, the zones 112a-N may be utilized to automatically enhance or restrict functionality and/or communication capabilities of the user device 108. As another example, the zones 112a0N may be utilized to automatically control, alter, enhance, and/or share attributes stored on the user device 108 (e.g., attributes describing characteristics or profiles of the user 104, the user device 108, or entities associated therewith). As yet another example, combinations of the above-described examples can be implemented.

In particular, the zone or zones 112a-N in which a user device 108 is located may dictate the functionality and/or communication capabilities of the user device 108. As can be seen in FIG. 1, some zones may overlap with other zones (e.g., first zone 112a overlapping with second zone 112b and third zone 112c), some zones may not be coincident with any other zone (e.g., the nth zone 112N), and some zones may be completely within another zone (e.g., second zone 112b within the first zone 112a).

The zones 112a-N may correspond to physical boundaries or logical boundaries. For example, the boundaries of a zone may be defined by a building's outer perimeter. As another example, the boundaries of a zone may be defined by a room within a building or a set of rooms within a building. As another example, the boundaries of a zone may correspond to an area where certain actions (e.g., gambling, communicating, viewing web-based content, etc.) are either allowed, controlled, or prohibited.

In some embodiments, the concept of rich presence information, geopods, and/or geofencing may be utilized to control functionality of the user device 108 or initiate one or more trigger events. In such architectures, rules may be provided that define, based on presence information of the user 104 and/or location of the user device 108, certain events or actions that occur when the rules are satisfied or fail to be satisfied. Additional details related to geopods and geofencing techniques are described in one or more of U.S. patent application Ser. Nos. 12/713,512, filed Feb. 26, 2010, and 12/702,764, filed Feb. 9, 2010, both of which are hereby incorporated herein by reference in their entirety.

In some embodiments, if a user's 104 presence is detected in one zone and that user's user device 108 is detected in another different zone that does not overlap with the zone in which the user's presence is detected, one or more alerting or notification events may be triggered. For example, detection of such an event may signify that the user 104 has been separated from their user device 108, for whatever reason, and the entity (e.g., hospitality vendor) which supplied the user 104 with the user device 108 may want to be notified of such an occurrence.

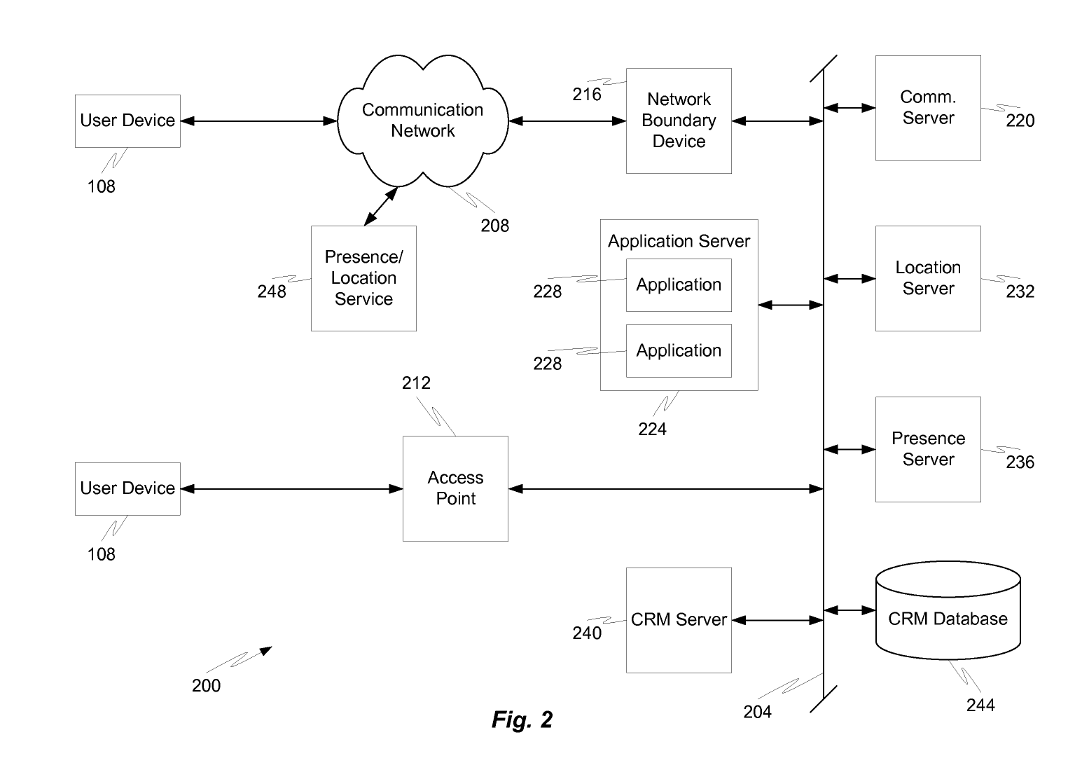

Referring now to FIG. 2, additional details of a communication system 200 will be described in accordance with at least some embodiments of the present invention. The communication system 200 may include one or more of user devices 108 (which may or may not have been distributed by a common hospitality vendor) which are in communication with an enterprise network, which may encompass some or all of the network devices depicted in FIG. 2.

In some embodiments, an enterprise network includes a Local Area Network (LAN) 204 that is connected with a larger communication network 208 via a network boundary device 216. User devices 108 may be enabled to connect to the LAN 204 via the communication network 208 and network boundary device 216. Alternatively, or in addition, a user device 108 may be enabled to connect with the LAN 204 via one or more access points 212 provided within the enterprise network (and usually provided within the physical boundaries of the hospitality vendor administering the enterprise network). In some embodiments, the communication range of all access points 212 provided within an enterprise network may correspond to the boundaries of a zone (e.g., first zone 112a). In some embodiments, the communication range of a single access point 212 may correspond to the boundaries of a zone (e.g., second zone 112b or third zone 112c).

The communication network 208 may comprise any type and any number of communication mediums and devices which are capable of supporting communication sessions, such as voice calls, video calls, chats, emails, TTY calls, multimedia sessions, or the like. In situations where the communication network 208 is composed of multiple networks, each of the multiple networks may be provided and maintained by different network service providers. Alternatively, two or more of the multiple networks in the communication network 208 may be provided and maintained by a common network service provider or a common enterprise in the case of a distributed enterprise network.

Exemplary types of communication networks 208 include, without limitation, another LAN, multiple LANs, a Wide Area Network (WAN), an enhanced IP-based network, a circuit-switched network, a Session Initiation Protocol (SIP) network, the Internet, the Public Switched Telephone Network (PSTN), a Plain Old Telephone System (POTS) network, an Integrated Serviced Digital Network (ISDN), a cellular communications network (e.g., 3G, 4G, etc.), an IP Multimedia Subsystem (IMS) network, or the like. In addition, it can be appreciated that the communication network 208 need not be limited to any one network type, and instead may be comprised of a number of different networks and/or network types.

Although not depicted, a user device 108 may also connect directly to the LAN 204. This is usually achieved by plugging the user device 108 into a communication port (e.g., Ethernet port) of the LAN 204. Such a port may be considered a wired access point 212.

The LAN 204 may be considered a secure LAN by virtue of the fact that the network boundary device 216 and/or access point 212 comprises security mechanisms, which enable only trusted communications to enter the LAN 204. For instance, the network boundary device 216 may include a firewall that has rules programmed therein for filtering packets and other forms of communication that are received at the network boundary device 216. If a received packet does not pass the firewall rules or is otherwise excluded by the firewall rules, then that received packet is not passed to the LAN 204. Likewise, the access point 212 may be secured by an encryption key or similar security mechanism which limits access through the access point 212 to trusted user devices 108 having the encryption key. For instance, the access point 212 may be secured with Wi-Fi Protected Access (WAP and WPA2) keys, Wired Equivalent Privacy (WEP) keys, Temporal Key Integrity Protocol (TKIP) keys, private keys, public/private key pairs, and the like. A user device 108 which cannot provide the required keys to the access point 212 will be denied access to the LAN 204. As such, the access point 212 can be either a wired, wireless, or combination wired/wireless access point.

The network boundary device 216 may correspond to a gateway or similar protocol translation device. Another exemplary type of network boundary device 216 includes a Session Border Controller (SBC), which is a device used at the boundaries of domains. SBCs may include the functionality sufficient to allow a domain to exert control over the signaling of a communication session and usually also the media streams involved in setting up, conducting, and tearing down communication sessions. SBCs may also provide measurement, access control, and data conversion facilities for the communications they control.

Whether a gateway, SBC, or other type of boundary device, the network boundary device 216 may comprise functionality which enables communications between computer or communication networks that use different communications protocols. For instance, the network boundary device 216 may enable a SIP-based LAN 204 to interconnect with a non-SIP-based communication network 208. Alternatively, the network boundary device 216 may enable a packet-based communication network to interconnect with a circuit-based communication network.

Additional network devices may be provided by the hospitality vendor and one or more of such devices may be connected to the LAN 204. Examples of such devices include a communication server 220, an application server 224 having one or more applications 228 thereon, a location server 232, a presence server 236, a customer relationship management (CRM) server 240, and CRM database 244.

The communication server 220 is a server which may be used to facilitate communications between user devices 108, incorporate various features into a communication session, or facilitate conferencing services. The communication server 220 can include a PBX, an enterprise switch, an enterprise server, or other type of telecommunications system switch or server. The communication server 220 is preferably configured to execute telecommunication applications such as the suite of MultiVantage™ or Avaya Aura™ applications of Avaya, Inc., including Communication Manager™, Aura Communication Manager™, Avaya IP Office™, and MultiVantage Express™

The communication server 220, in some embodiments, includes one or more conferencing applications and associated hardware, such as MultiPoint Conferencing Units™ (MCU), Unified Conferencing™, Web Conferencing™, IP Office Conferencing™, and/or Meeting Exchange™ of Avaya, Inc.

As can be appreciated, one or more of the features provided by the communication server 220 may not necessarily be provided by a user device 108 on its own. This provides one reason why it may be desirable for a user device 108 to connect with the LAN 204; the enterprise network can provide feature offerings to the communication session participants not otherwise available.

While some of the feature offerings of the enterprise network 204 may be provided by the communication server 220, other features may be provided by one or more applications 228 residing on an application server 224. Examples of such applications 228 include, without limitation, an EC-500 (extension to cellular) application, a call setup application, a voicemail application, an email application, a voice application, a video application, a text application, a conferencing application, a call recording application, a communication log application, a security application, an encryption application, a collaboration application, a whiteboard application, mobility applications, presence applications, media applications, messaging applications, bridging applications, a hospitality application, a presence application, a security application, a scheduling application, a location application, a personal profile application, a news feed application, and any other type of application that can supplement or enhance communications or functionality of the user device 108. Additionally, one, two, three, or more applications of a given type can be incorporated into a single communication session or single service offering without departing from the scope of the present invention.

The location server 232 may be provided to obtain and/or analyze location information for one or more user devices 108. In particular, the location server 232 may be adapted to receive location information from a user device 108 or some third-party location server 248 and compare such location information to the location of the zone boundaries. The location information may be provided in any number of formats and may be obtained may any number of mechanisms. Some examples include Global Positioning System (GPS) location information, cellular triangulation location information (e.g., GSM locating done by multilateration based on signal strength to nearby cellular antennas), and the like. The location information received regarding a user device 108 can be analyzed by the location server 232 with respect to the boundaries of the zones 112.

The presence server 236 may be provided to obtain and/or analyze presence and/or location information for one or more users 104. The presence server 236 may be provided with the capability to determine whether a user 104 is registered with and using a particular user device 108, whether a user 104 is co-located with a particular user device 108, and whether the user 104 is using a particular communication modality offered by a user device 108. In some embodiments, the presence server 236 obtains presence information by monitoring the system 200 for activity of the user 104. In some embodiments, the presence server 236 obtains presence information from a third-party presence server 248 that is capable of monitoring the system 200 for activity of the user 104. As can be appreciated by those skilled in the art, the presence/location service 248 may be within the enterprise network (i.e., owned and operated by the same entity that administers the LAN 204) or it may be outside of the enterprise network and operated by a different entity.

In some embodiments, the presence server 236 provides a presence awareness module that makes use of and enforces location-based functionality of the user devices 108. In some embodiments, the presence server 236 includes a gaming/gambling modules that would provide users 104 with the ability to play electronic games and gamble via their user device 108. The gaming/gambling module provided by the presence server 236 may consider location and/or presence information to enforce limitations on gaming and gambling abilities.

The CRM server 240 may be provided to obtain customer information, categorize such information, store the categorized information into the CRM database 244, and later utilize information from the CRM database 244 to offer the customer personalized services. In some embodiments, the CRM server 240 is configured to obtain information related to a customer's previous interactions with the entity hosting the enterprise network (e.g., a particular hospitality vendor). The CRM server 240 does not necessarily have to limit its information retrieval to subsequent enterprise/customer interactions, but the CRM server 240 may also be enabled to obtain information directly from a customer (e.g., as a part of a customer registration process) or from other publicly-available sources of information (e.g., social networking websites, news articles, blog postings, etc.). The CRM server 240 may also be configured to utilize such information in determining potential service offerings for the customer during subsequent interactions. Moreover, user profiles on the user device 108 can be automatically populated by the CRM server 240 with information from the CRM database 244.

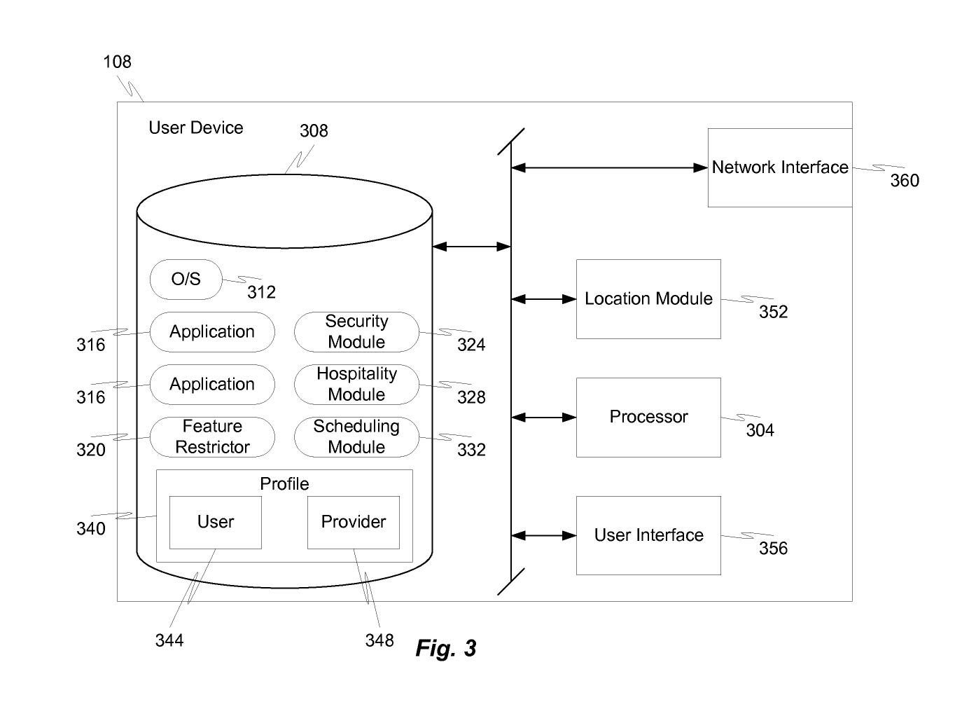

With reference now to FIG. 3, additional details of a user device 108 will be described in accordance with at least some embodiments of the present invention. The user device 108 may include a processor 304, a memory 308, a location module 352, a user interface 356, and a network interface 360.

The processor 304 may include a microprocessor, Central Processing Unit (CPU), a collection of processing units capable of performing serial or parallel data processing functions, and the like.

The memory 308 may include a number of applications or executable instructions that are readable and executable by the processor 304. For instance, the memory 308 may include instructions in the form of one or more modules and/or applications. The memory 308 may also include data and rules which can be used by one or more of the modules and/or applications. Exemplary applications include an operating system 312 and various other applications 316. The operating system 312 is a high-level application which enables the various other applications 316 and modules to interface with the hardware components (e.g., processor 304, network interface 360, and user interface 356) of the user device 308. The operating system 312 also enables a user of the user device 108 to view and access the applications 316 and modules in memory 308.

Although the applications and modules are depicted as software instructions residing in memory 308 and those instructions are executable by the processor 304, one skilled in the art will appreciate that the applications and modules may be implemented partially or totally as hardware or firmware. For example, an Application Specific Integrated Circuit (ASIC) may be utilized to implement some or all of the functionality discussed herein.

Exemplary features offered by the applications 316 include, without limitation, communication features (e.g., voice communication applications, text communication applications, video communication applications, multimedia communication applications, etc.), user interface features, web-browsing features, gaming/gambling features, and so on. Specific modules which may be included in memory 208 include, without limitation, a feature restrictor 320, a security module 324, a hospitality module 328, and a scheduling module 332.

The memory 308 may also include a communication module, instead of one or more communication-based applications, which provides the communication functionality of the user device 108. In particular, the communication module may contain the functionality necessary to enable the user device 108 to communicate with other user devices 108 across a communication network 204, 208. As such, the communication module may have the ability to access user communication preferences maintained within a locally-stored profile 340, format communication packets for transmission via the network interface 360, as well as condition communication packets received at a network interface 360 for further processing by the processor 304.

The feature restrictor 320 may be enabled to restrict, permit, or otherwise control functionality of the user device 108. In particular, the feature restrictor 320 may work in cooperation with a location module 352 to determine location information for the user device 108 and/or presence information for the user 104 of the user device 108 to determine how and to what extent functionality of the user device 108 should be controlled. The types of functions which may be subjected to control by the feature restrictor 320 include, without limitation, communication functions, gaming/gambling functions, security functions offered by the security module 324, hospitality functions offered by the hospitality module 328, scheduling functions offered by the scheduling module 332, and profile sharing functions. Other functions which may be controlled by the feature restrictor 320 will become apparent to those skilled in the art.

The security module 324 may be enabled to control security functions of the user device 108. In some embodiments, the security module 324 may be configured to manage security for transactions between the user device 108 and other devices. Such transactions may include data-sharing transactions and monetary transactions such as credit transactions, debit transactions, or specialized line of credit transactions. The security module 324 may have or have access to one or more encryption keys which enables the security module 324 to facilitate sensitive communications over a public or untrusted communication network 208. The security module 324 may also be configured to implement 304 user authentication mechanisms to protect the user 104 should they lose the user device 108. The security module 324 may further act as the gatekeeper with regard to special access or permission capabilities within a hospitality environment. For example, if the user device 108 is Near Field Communications (NFC) enabled, the security module 324 may be configured to control interactions between the user device 108 and access control modules (e.g., RFID readers positioned at a door or access point of a building).

The hospitality module 328 may be configured to provide hospitality services to the user 104 of the user device 108. The hospitality module 328 may utilize information contained in the profile 340 of the user device 108 to offer a complete menu of services, reservations, capabilities, concierge, and the like offered by a hospitality vendor. The hospitality module 328 may also facilitate specialized queries, the ability to lock, unlock, or check on room status (by operating in cooperation with the security module 324), and the like. The hospitality module 328 may further include a news feed portion which provides sports scores, major news, specialized time-sensitive discount opportunities, and other such bulletins that the user 104 may want to subscribe to (e.g., as determined or inferred by referencing a user portion 344 of the locally-maintained profile 340).

The scheduling module 332 may be configured to enable a user 104 to set-up and manage their schedule while a guest of the hospitality vendor. In some embodiments, the scheduling module 332 may be enabled to import a user's 104 personal schedule from another personal communication device of the user 104 or scheduling server (e.g., a user's personal Outlook calendar event can be imported into a user's vacation schedule via the scheduling module 332). The scheduling module 332 may also function based on location information received from the location module 352, location server 232, and/or location service 248. In particular, the scheduling module 332 may consider a current location of a user 104 and/or the user device 108 and calculate an estimated travel time to arrive at a destination or meeting point and automatically configure the timing with which a reminder is provided to the user 104 based on the estimated travel time. The scheduling module 332 may further provide suggested instructions for reaching a venue where a particular meeting is set to occur.

In addition to containing one or more applications and/or modules, the memory 308 may also contain one or more data structures which enable the functionality of the user device 108. In particular, the memory 308 may include profile information 340 which may comprise a user portion 344 and a provider portion 348. The user portion 344 may correspond to profile information specific and possibly customizable for a user 104 of the user device 108, whereas the provider portion 348 may correspond to profile information dictated and controlled by the provider of the user device 108 (e.g., a hospitality vendor).

In some embodiments, the profile 340 is stored directly on the user device 108. In some embodiments, the profile 340 may be stored by the enterprise and pushed to the user device 108 on an as-needed basis. In some embodiments, a portion of the profile 340 is stored locally on the user device 108 and another portion of the profile 340 is stored at an enterprise and provided on an as-needed basis.

The network interface 360 comprise components for connecting the user device 108 to the communication network 204 and/or 208. In some embodiments, a single network interface 360 connects the user device to multiple networks. In some embodiments, a single network interface 360 connects the user device 108 to one network and an alternative network interface is provided to connect the user device 108 to another network.

The network interface 360 may comprise a communication modem, a communication port, or any other type of device adapted to condition packets for transmission across a communication network 204 and/or 208 to a destination user device 108 as well as condition received packets for processing by the processor 304. Examples of network interfaces include, without limitation, a network interface card, a modem, a wired telephony port, a serial or parallel data port, radio frequency broadcast transceiver, a USB port, or other wired or wireless communication network interfaces.

The user interface 356 may include a user input and/or user output device. The user interface 340 enables a user to interact with the user device 108. Exemplary user input devices which may be included in the user interface 356 comprise, without limitation, a microphone, a mouse, trackball, rollerball, or any other known type of user input device. Exemplary user output devices which may be included in the user interface 356 comprise, without limitation, a speaker, light, Light Emitting Diode (LED), display screen, buzzer, or any other known type of user output device. In some embodiments, the user interface 356 includes a combined user input and user output device such as a touch-screen.

The location module 352 may include software and/or hardware components which enable the location of the user device 108 to be determined. In some embodiments, the location module 352 comprises a GPS module that is capable of facilitating the ability to determine GPS location information for the user device 108.

As can be appreciated by one skilled in the art, functions offered by the modules depicted in FIG. 3 may be implemented in one or more network devices (i.e., servers connected to the LAN 204). Likewise, functions offered by one or more network devices may be implemented as a module of the user device 108.

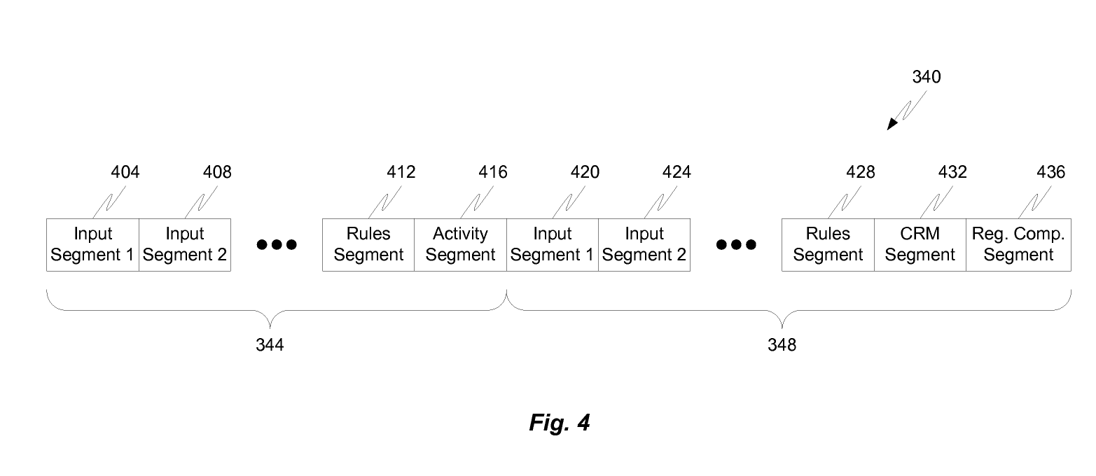

An embodiment of a profile data structure 340 is shown in FIG. 4. The data structure 340 can be stored in several different forms of databases, such as relational databases, flat files, object-oriented databases, etc. Thus, while the term “data field” or “segment” is used, the data may be stored in an object, an attribute of an object, or some other form of data structure. Further, the data structure 340 can be stored, retrieved, sent, or received during the processing communication session information by one or more of the modules discussed herein. The data structure 340 stores one or more items of information in one or more data fields. The numeric identifiers (e.g. 404, 408, etc.) shown in FIG. 4 can identify, in one or more fields or segments, either the data field or segment or the data stored in the data field or segment.

The data structure 340 may be separated into two or more portions, although such a separation is not required. For example, the data structure 340 may comprise a user portion 344 and a provider portion 348. Each portion can include one or more input segments, such as, input segment 1 404, 420 and input segment 2 408, 424, a rules segment 412, 428, and other segments specific to that portion. Input segments each include one or more fields comprising the one or more inputs that may be required to determine user communication preferences, hospitality preferences, gaming/gambling preferences, security preferences, news feed preferences, etc. The input segments may include a user identity, a user's outbound call-processing preferences, a user's inbound call-processing preferences, a user's multimedia communication preferences, a user's roaming profile, a user's communication history, a list of contacts, account information, line of credit information, passwords, encryption keys, etc.

As can be appreciated, the data structure 240 may be stored partially or entirely in one or more servers depicted in FIG. 2. While there are only two input segments shown per-portion in FIG. 4, there may be more or fewer input segments associated with the data structure 240, as indicated by the ellipses.

The rules segment 412, 428 can include one or more heuristic rules that either help with identifying when to enable a particular module or service or controlling a module or service once invoked. For example, the rule 412 can state that the data structure 340 applies to a communication session only if the communication session includes input segment 1 404 but not input segment 2 408 One skilled in the art will be able to identify other types of rules that may govern the association of the data structure 340 with various types of data inputs created within the network 200 (e.g., location data inputs, presence data inputs, communication activity data inputs, device operation data inputs, etc.). Accordingly, multiple data structures 340, such as those depicted in FIG. 4, may be contained within the profile preferences of memory 308. In some embodiments, some data structures 340 may include both a user portion 344 and a provider portion 348. In some embodiments, a data structure 340 may include only a user portion 344 or only a provider portion 348.

Generally, an activity segment 416 includes a list of activities previously done by a user and/or a list of activities which a user desires to do during their stay. The activity segment 416 may also include rules for suggesting activities to a user.

The provider portion 348 may also contain one or more specialized segments such as a CRM segment 432 and a regulatory compliance segment 436. The CRM segment 432 may be the provider's version of the activity segment 416 found in the user portion 344 in that the CRM segment 432 may provide rules for suggesting activities and other services to a user. Furthermore, the CRM segment 432 may contain rules which allow the provider of the user device 108 to track activities (both current and past) of a user 104 to help refine the activity suggestions provided to the user.

The regulatory compliance segment 436 is a specific data segment which may contain any rules, regulations, statutes, etc. and instructions for abiding by said rules. As one example, the regulatory compliance segment 436 may contain data describing gambling and/or gaming rules for a particular jurisdiction in which the user device 108 is located. As another example, the regulatory compliance segment 436 may contain data describing gambling and/or gaming rules around the entire world and based on the location of the user device 108, the applicable rules are utilized to control the operation of the device. Regardless of the way in which the regulatory compliance segment 436 is organized and constructed, the data segment may be used to ensure that the user 104 of the user device 108 does not violate any such rule via utilization of the user device 108. Thus, if the user 104 is utilizing the user device 108 for gambling in a particular casino and that user tries to walk out of the casino with the user device 108, then the application 316 supporting the gambling functions of the user device 108 may be either terminated or at least suspended until the user 104 takes the user device 108 into another area in which gambling is permitted, at which point the application 316 supporting the gambling functions of the user device 108 may be re-invoked or unsuspended.

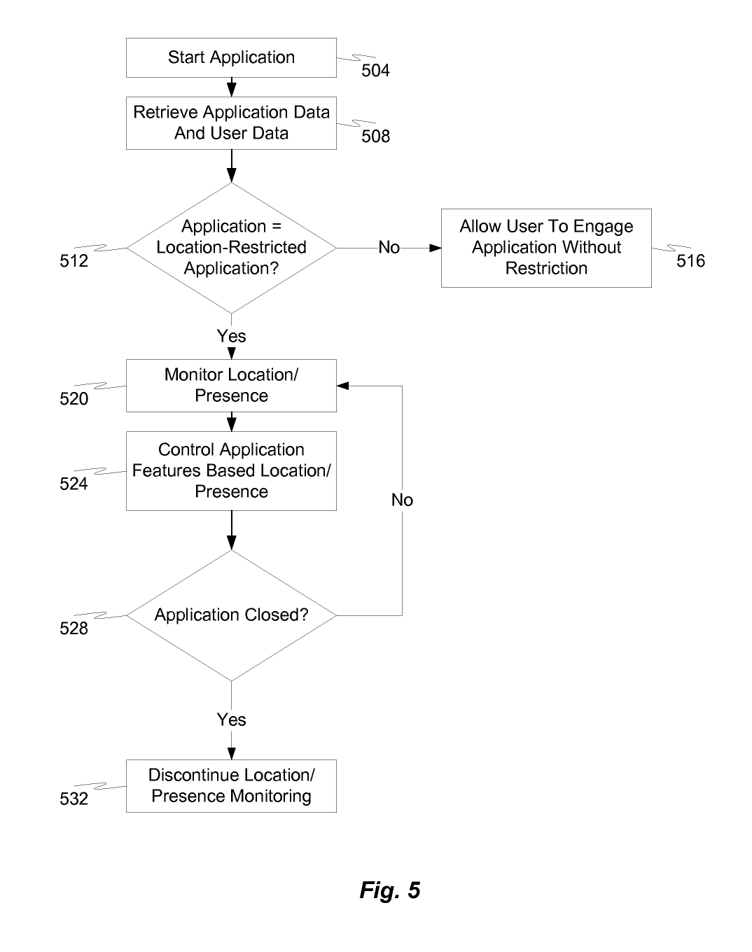

With reference now to FIG. 5, an exemplary method of controlling applications on or available to a user device 108 in accordance with at least some embodiments of the present invention. The method begins when an application is started (step 504). The application can include any type of known application or computer-provided service including, without limitation, a gaming application, a gambling application, a security module 324, a hospitality module 328, a scheduling module 332, a CRM application, a communication application, etc. Once invoked, the application retrieves the necessary application data and user data to enable the functionality of the application (step 508). In some embodiments, it may not be necessary to retrieve user data as the application is user-agnostic. In some embodiments, retrieval of user data may include retrieving data from the profile 340. As an example, if the application is a gambling application, then the application may retrieve one or more data structures 340 containing necessary regulatory compliance information, user account information (e.g., how much money does the user 104 have available for gambling purposes, user spending limits, gambling profile), etc.

The method continues by determining whether the application is a location-restricted application (step 512). This determination may be made based on the data retrieved in step 508 or it may be hard-coded into the application itself. The types of applications which may be considered non-location-restricted include certain communications applications, non-regulated gaming applications, and the like. However, it is equally likely that any application can qualify as a location-restricted application because such restrictions also typically involve enhanced feature offering based on location.

If the query of step 512 is answered negatively, then the method proceeds by allowing the user 104 to engage the application without a location-based restriction (step 516). Otherwise, the method continues with the feature restrictor 320 beginning a process whereby the presence of the user 104 and/or location of the user device 108 is monitored (step 520). In some embodiments, the presence and location information is monitored continuously. In some embodiments, the presence and location information is monitored periodically. In some embodiments, one type of information may be monitored continuously whereas another type of information may be monitored periodically.

The feature restrictor 320 may obtain presence information by directly monitoring the user's 104 interaction with the user device 108 or by requesting presence information from a presence server 236 and/or presence service 248. Similarly, the feature restrictor 320 may obtain location information directly from the location module 352, from the location server 232, and/or from a location service 248.

The feature restrictor 320 then utilizes the presence and/or location information to control features of the application (step 524). In some embodiments, the feature restrictor 320 may restrict one or more features available to a user 104 via the application. In some embodiments, the feature restrictor 320 may enhance one or more features available to the user 104 via the application. In some embodiments, some features of the application may be restricted while other features are enhanced.

The feature restrictor 320 may also be configured to control the application features based on the user's 104 presence information and the user device's 108 location information. In particular, if the user's device 108 is found to be within one zone 112 and the user 104 is found within another different zone 112 then certain features may either be invoked or restricted based on making such a determination.

The method continues by determining whether the application has been closed (step 528). The closing of an application represents a user's 104 discontinued use of the application via the user device 108. The application may have been closed due to the feature restrictor 320 determining that the user device 108 is within a zone where the application's use is restricted (e.g., a communication application may be disabled in certain gambling zones, theater zones, restaurant zones, or the like). Alternatively, the application may have been closed due to the user 104 manually closing the application. Regardless of how the application was closed, if the application is determined to be closed, then the feature restrictor 320 discontinues monitoring the location and/or presence information (step 532). Otherwise, the method returns to step 520.

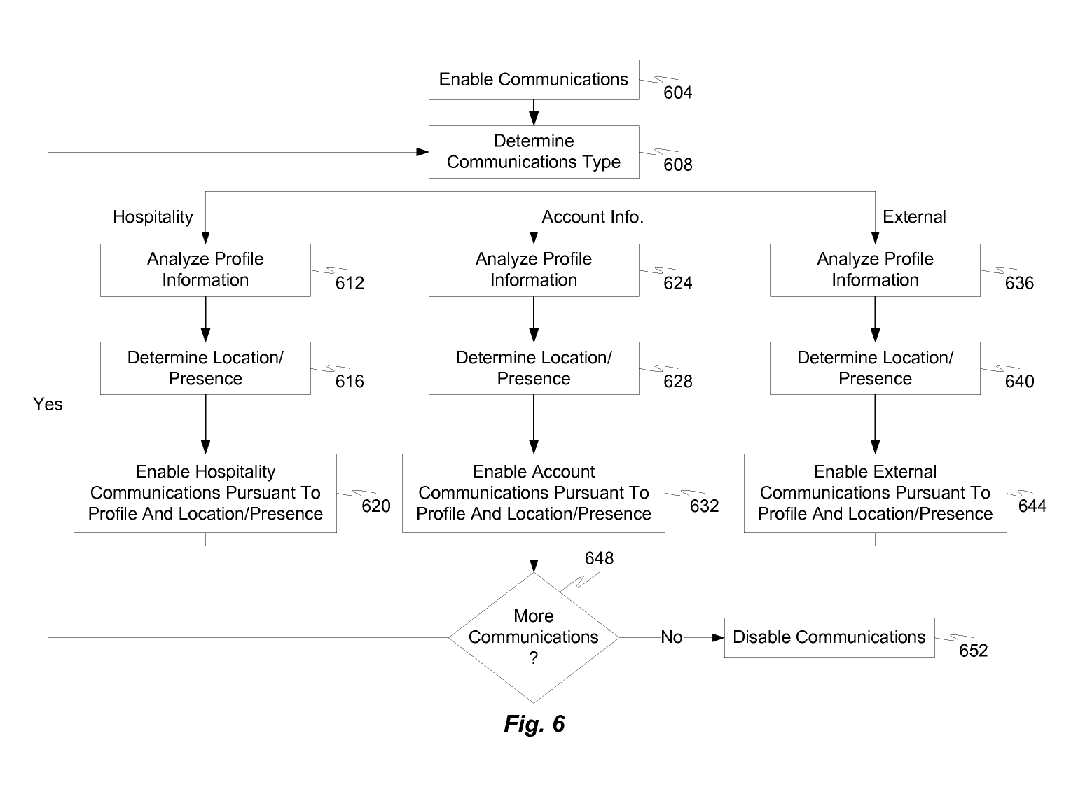

With reference now to FIG. 6, an exemplary communication method will be described in accordance with at least some embodiments of the present invention. The method is initiated when communications are enabled on a user device 108 (step 604). This may occur automatically when the user device 108 is turned on. Alternatively, communications may be enabled when a user 104 opens a communication application, attempts initiating a communication, and/or receives a communication request. In some embodiments, the attempted initiation of a communication may correspond to a user 104 calling or otherwise sending another user a communication-initiation message. In some embodiments, receiving a communication request may correspond to a user receiving an inbound call or some other form of communication-initiation message.

Thereafter, the method continues by determining the communication type (step 608). While communications may come in many different types, the user device 108 being well-suited for use in the hospitality environment may experience certain types of communications more frequently than others. Those types of communications which may be experienced more frequently include, without limitation, a hospitality-based communication, an account-based communication, and an external communication. Each of these specific types of communications will be discussed in connection with FIG. 6, although one skilled in the art can appreciate that many other types of communications can also be implemented in a similar fashion.

If the communication corresponds to a hospitality-based communication, then the method continues with the hospitality module 328 retrieving and analyzing the information contained in the profile 340 to determine if any information is pertinent to the current communication (step 612).

Where the hospitality-based communication was initiated by the user device 108 (e.g., the user 104 called a hospitality number or invoked the hospitality module), the hospitality module 328 may automatically retrieve the relevant information from the profile 340. Moreover, the hospitality module 328 may query the user 104 as to the specific nature of the communication to further refine its search of the profile 340 as well as include such information with the outbound communication.

Where the hospitality-based communication is received at the user device 108 (e.g., because it was initiated by the hospitality vendor or an employee thereof), the hospitality module 328 may not begin retrieving or analyzing the profile information until after the communication session has been established, although it may perform some retrieval and analysis before the communication session is established.

The types of profile information retrieved for the hospitality-based communication includes, without limitation, user activity preferences, user activity history, user budget, user schedule, user status (e.g., platinum, gold, silver, bronze, etc.), and the like.

After the requisite profile information has been retrieved and analyzed, the method continues by determining presence information about the user 104 and/or location information about the user device 108 (step 616).

Based on the profile information, user 104 presence information, and/or user device 108 location information, the hospitality module 328 may enable conditions to accommodate the user 104 and the user's current situation, as may be determined by the presence and/or location information (step 620). As one example, the hospitality module 328 may automatically condition an outbound call to a hospitality number to be converted into a video call with a customer-service representative. As another example, the hospitality module 328 may determine re-route an outbound call to a hospitality number to an Interactive Voice Response (IVR) unit, which tells the customer that a customer-service representative has been dispatched to their current location. Many other types of communication modifications can be performed without departing from the scope of the present invention.

Thereafter, the method continues by determining whether additional communications are to be processed (step 648). If so, the method returns to step 608. If not, then the method ends by disabling the communication functions of the user device 108 (step 652). This may simply involve tearing down any previously established communication session and releasing any communication resource that was included in the session or it may include closing the communication application of the user device 108.

Referring back to step 608, if the communication is an account-based communication, then the method will proceed by invoking the security module 324 to retrieve and analyze any information from the profile 340 that may be relevant to the current communication (step 624). As with the hospitality module 328, the security module 324 may perform the retrieval and analysis steps at any point before or during the communication session, but it may be advantageous to perform at least some analysis of the profile information before establishing the communication session to reduce user wait-time.

Thereafter, the method continues with the security module 324 determining presence and/or location information for the user 104 and/or user device 108, respectively (step 628). The profile information, presence information, and/or location information is then used to enable and control various types of account-based communications (step 632). As one example, the security module 324 may allow a user 104 to update a line of credit for gambling purposes if the user 104 has the appropriate permissions in their profile 340 and the user 104 and user device 108 are located within a designated zone 112. As another example, the security module 324 may allow a user 104 to receive access privileges (e.g., access a restaurant, access a room, access account information, etc.) with their user device 108 if certain conditions are met. As another example, the security module 324 may allow a user to transfer monies between accounts, remotely check-out of their room, and perform various other types of account-based communications. Thereafter, the method continues to step 648.

Referring back to step 608 again, if the communication type corresponds to an external communication (e.g., an inbound or outbound call with a user device 108 connected to the communication network 208), then the method proceeds with the communication application retrieving and analyzing pertinent profile information from the profile 340 (step 636). As with other types of communications, the information may be retrieved from the user portion 344 of the profile 340 or the provider portion 348 of the profile 340. In addition to retrieving profile information, the communication application facilitating the external communication may also retrieve presence information about the user 104 and/or location information about the user device 108 (step 640).

All of this information can then be used to enable and control the external communication (step 644). As one example, if external communications or particular types of external communications (e.g., long-distance calls, 1-800 calls, VoIP calls, etc.) are allowed but require a billing module to be invoked, then the communication application may invoke the necessary billing module. As another example, if external communications are allowed in certain zones but not in other zones, then the communication application may restrict or permit external communications based on the location of the user device 108 and/or presence information of the user 104. As still another example, if only certain users 104 are allowed to place outbound external calls with the user device 108, then the user's status along with a simultaneous determination of presence and location information may be performed to determine that (i) the user 104 is co-located with the user device 108 and (ii) the user 104 is permitted to make such an external call. Thereafter, the method proceeds to step 648.

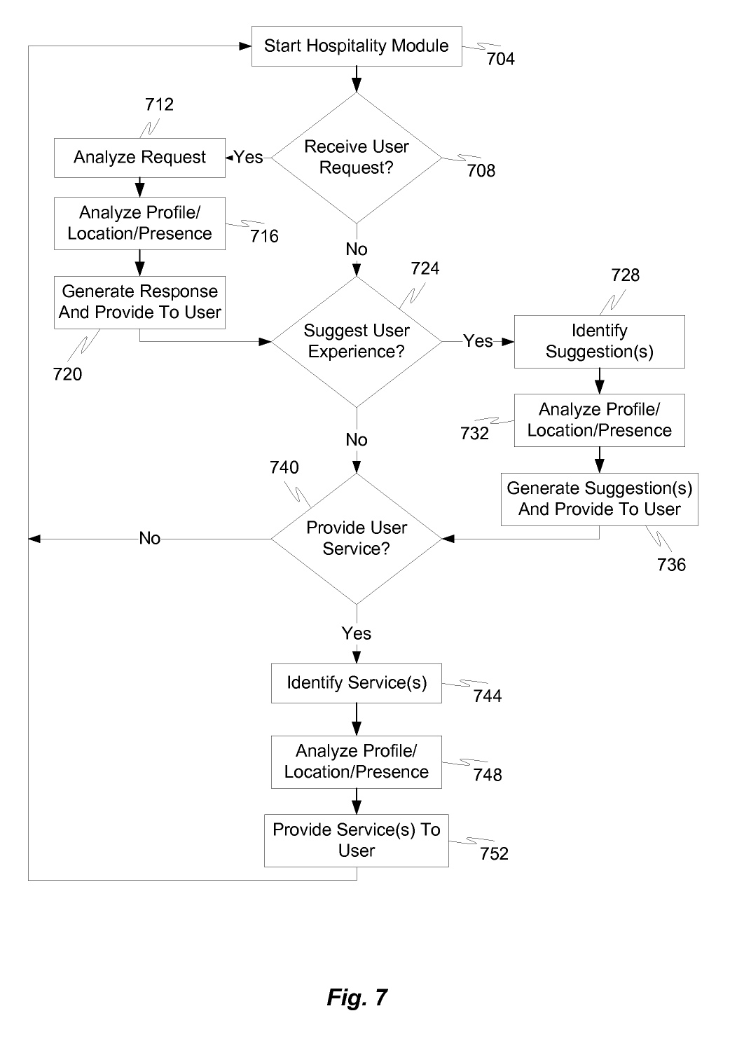

With reference now to FIG. 7, an exemplary hospitality method will be described in accordance with at least some embodiments of the present invention. The method begins when the hospitality module 328 is invoked (step 704). The hospitality module 328 may be automatically invoked when the user device 108 is turned on or the hospitality module 328 may be manually invoked when a user opens the hospitality module 328 from the general view of the O/S 312.

Once invoked, the hospitality module 328 waits until a user request is received (step 708). The user request may come in the form of receiving input at the user interface 356 or in the form of receiving an inbound hospitality-based communication. If a user request is received, then the method continues with the hospitality module 328 analyzing the request (step 712), determining profile, location, and/or preference information regarding the user 104 and/or the user device 108 (step 716), and generating a response which is subsequently provided to the user 104 (step 720). In particular, the hospitality module 328 may make use of the user's 104 identity information, the user's 104 preferences as defined in the profile 340, the user's 104 account information, room information, special status or permissions, access permissions, credits, vouchers, and the like. In some embodiments, the hospitality module 328 may receive a user input directing the user device 108 to conduct an authentication procedure with an access control device (e.g., an RFID reader protecting access to a room, similar physical asset, or logical asset) to allow the user 104 to gain access. In some embodiments, the user device 108 may be Near Field Communications (NFC) equipped, thereby allowing the user device 108 to also act as the user's 104 authentication credential.

After the response has been provided to the user, or in the event that no user request was received, the method continues with the hospitality module 328 determining whether a user experience should be suggested to the user 104 (step 724). This determination may be made automatically by analyzing the user's 104 schedule, presence information, and location of the user device 108 and determining that the user 104 has a break in current activity and, therefore, has some additional time to undertake another experience. Alternatively, this determination may be made when the user 104 affirmatively asks for a suggested experience. The hospitality module 328 may identify possible suggestions based upon the currently available experiences and an estimation of the amount of free time that the user 104 currently has (step 728).

As noted above, the hospitality module 328 may also consider profile, user presence, and/or device location information in refining experience suggestions for the user 104 (step 732). For example, the hospitality module 328 may suggest a complete menu of services, reservations, capabilities, concierge, and the like offered by a hospitality vendor. Alternatively, the hospitality module 328 may suggest that the user 104 temporarily engage another application on the user device 108 (e.g., a gambling application, gaming application, etc.) to fill their idle time.

Based on the identified suggestions and the profile, presence, and/or location information, the hospitality module 328 generates one or more suggestions and provides such suggestions to the user 104 via the user interface 356 (step 736). In one particularly useful example, the hospitality module 328 may determine that tickets/seats are still available to a particular show or event. The hospitality module 328 may consider a number of factors such as the amount of time until the event begins, the user's 104 current presence information and location of the user device 108 and based on all of the above-noted information offer the user 104 a discounted purchase price for the ticket. This allows the hospitality vendor to try and fill any empty seats at the last minute while also generating a specialized price based on the current supply and demand for the same. This may also help the hospitality vendor promote certain services or create a certain amount of advertising “buzz” before a particular event begins. If the user 104 decides to purchase tickets to the special event, the hospitality module 328 may automatically charge the user's 104 account and then generate directions to the location of the event. The directions provided to the user 104 may be dynamically adaptable based on current traffic conditions (e.g., foot traffic, road traffic, etc.), environmental conditions (e.g., determining that a non-smoker will likely not want have a route whereby they pass through a smoking area, weather conditions, etc.), and so on.

After appropriate suggestions and potential directions have been provided to the user 104, or in the event that no user experience was suggested, then the method continues with the hospitality module 328 determining whether to provide the user 104 with a service (step 740). If the answer to this query is no, then the method returns to step 704. Otherwise, the method continues with the hospitality module 328 identifying one or more services for the user 104 (step 744). The hospitality module 328 also analyzes information in the profile 340, user 104 presence information, and/or user device 108 location information (step 748). All of this information is then used to refine the possible services that could/should be provided to the user 104 (step 752).

Any number of services may be provided to a user 104 in accordance with embodiments of the present invention. As one example, the hospitality module 328 may determine that the user 104 is interested in receiving news updates, sports scores, market updates, and other specialized bulletins. These services can be provided by presenting the relevant information on the user interface 356 as they are received at the hospitality module 328. Other types of services that may be provided by the hospitality module 328 include virtual wait-in-line services whereby the hospitality module 328 places the user 104 in a virtual queue to wait for a concierge, customer service representative, manager, etc. These types of services allow the user 104 to remain in their current location while waiting in a virtual queue for another service.

The services could be provided to the user 104 according to communication preferences of the user 104. For example, some users may prefer to receive notification of services via email whereas other may prefer to receive notification of services via IM. Still other users may prefer to receive notification of services via a voice message. The hospitality module 328 can accommodate any of these user preferences and store such information in the CRM database 244 for subsequent visits. After the appropriate service(s) have been provided to the user 104, the method returns to step 704.

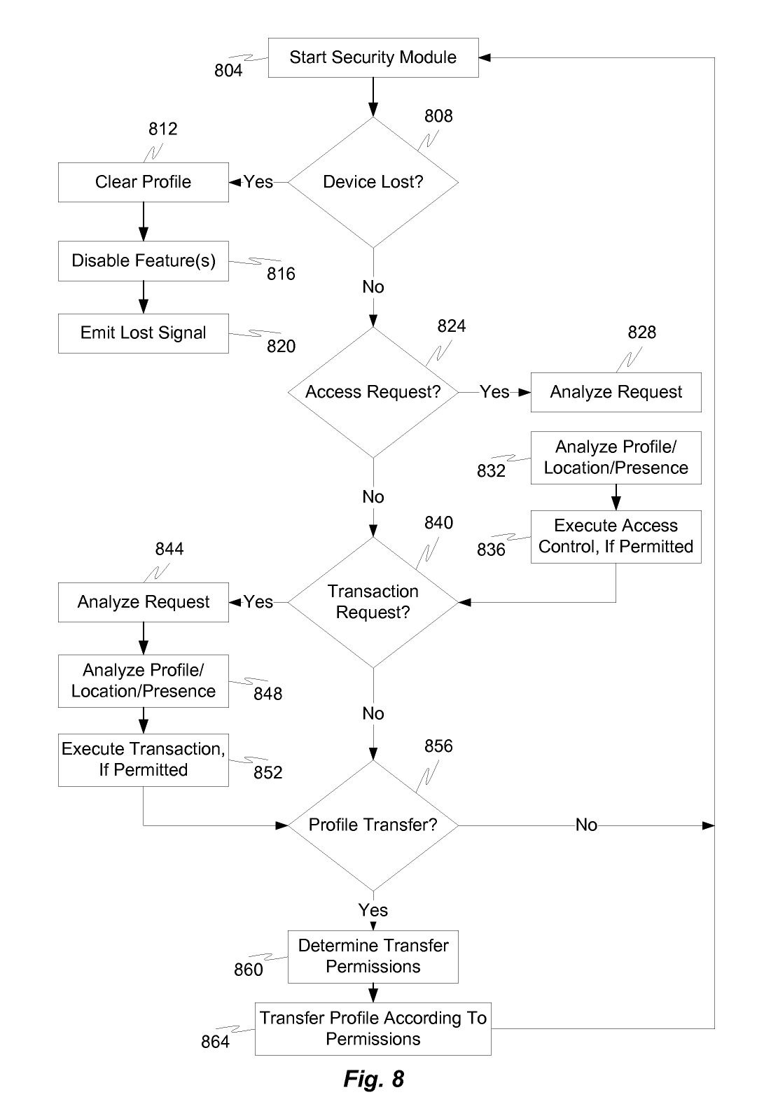

Referring now to FIG. 8, an exemplary security method will be described in accordance with at least some embodiments of the present invention. The method is initiated when the security module 324 is invoked (step 804). Similar to other modules discussed herein, this may occur either automatically or manually invoking the security module 324.

Once the security module 324 has been invoked, the method continues with the security module 324 determining if the user device 108 has been lost (step 808). This step may involve the security module 324 analyzing the user's 104 presence information and comparing it with the user device's 108 location information to determine if the user 104 is co-located with the user device 108. If the security module 324 determines that the user 104 has been separated from their user device 108, then the security module 324 may either automatically assume that the user device 108 has been lost or may further analyze the location of the user device 108 to determine if it is in a trusted zone. If the user device 108 is found within a trusted zone (e.g., a room of the user 104), then the user device 108 may not be considered lost. Alternatively, a user 104 may proactively report the user device 108 as lost, in which case the query of step 808 is answered affirmatively.

If the user device 108 is determined to be lost, then the method continues with the security module 324 clearing some or all of the profile 340 information (step 812). This step may be performed remotely by the security module 324 generating a command to erase information contained within memory 308. Alternatively, this step may involve a third-party, such as a hospitality system administrator transmitting to the user device 108 a command which causes the user device 108 to delete information in the profile 340.

The method continues with the security module 324, or some other entity, disabling one or more features of the user device 108 (step 816). The types of features which may be disabled include, without limitation, gambling features, gaming features, communication features, user interface 356 features, and the like. As can be appreciated, zero, one, two, three, or more features may be disabled with a single command.

Thereafter, a lost signal may be emitted either by the user device 108 to a predetermined number or electronic address or via the user interface 356 of the user device 108 (step 820). The emission of the lost signal allows other interested parties to (i) identify that the user device 108 has been lost and (ii) begin the process of retrieving the user device 108.

Referring back to step 808, if the user device 108 is not determined to be lost, then the method continues with the security module 324 determining whether an access request has been received (step 824). This query may be answered affirmatively if a user request is received to perform an access process or if the user device 108 is presented to an access control reader and access control functionality of the user device 108 is automatically engaged (e.g., by virtue of the fact that the user device 108 has received an energization signal or the like from the access control reader). Of course, an access request may correspond to a user's 104 request to access a logical asset, such as account information, permissions, line-of-credit information, and the like.

If an access request has been received, the method continues with the security module 324 analyzing the request (step 828), analyzing current profile, location, and/or presence information (step 832), and executing an access control command, if such an execution is permitted (step 836). In some embodiments, the security module 324 retains control of the access control decision until it determines that any profile, location, and/or presence requirements are satisfied. Upon making such a determination, the security module 324 may enable a NFC module of the user device 108 or some other access control module to communication with the access control reader.

If the security module 324 does not determine that access control is permitted, then the security module 324 may withhold transmitting an enablement command to an access control module of the user device 108. Alternatively, the security module 324 may transmit a signal to an access control module of the user device 108 instructing the access control module to not perform any further access control operations for a predetermined amount of time.

Thereafter, or in the event that no access request is received, the method continues with the security module 324 determining whether a transaction request has been received (step 840). A transaction request may vary from an access request in that a transaction request may involve actually controlling or interacting with an asset whereas an access request may simply involve viewing an asset. As a prime example, account information may be accessed via an access request, but funds may not be transferred between, into, or out of accounts unless a transaction request is granted.

Upon receiving the transaction request, the security module 324 may analyze the request and the parameters thereof (step 844), analyze relevant profile, location, and/or presence information (step 848), and then execute the requested transaction if the requirements of the request are satisfied by the profile, location, and/or presence information (step 852). Other types of transactions which may be carried out under this particular process include, without limitation, extending lines of credit, transferring funds between accounts, cashing out gambling accounts, placing bets, remotely checking-out, and the like.

Thereafter, or in the event that no transaction request has been received, the method continues with the security module 324 determining whether a profile transfer has been requested (step 856). A profile transfer is a way in which a user 104 may transfer some or all of their profile 340 to another user 104 if the transferring user 104 has the adequate permissions. As one example, a father that is a guest of a particular hotel may elect to transfer all of his profile 340 to his wife and a portion of his profile to his daughter. In the profile transfer process the entire profile 340 may be transferred, a specific portion of the profile 340 may be transferred (e.g., the user portion 344, the provider portion 348, or portions thereof), or a segment of the profile 340 may be transferred (e.g., specific rule segments may be transferred or specific data segments containing the ability to access lines of credit may be transferred).

Generally speaking, it may not be advantageous to allow any user to transfer their profile 340 at their leisure. Rather, it may be desirable to restrict profile transfers to either selected customers, to selected circumstances, or both. Thus, if a profile transfer request is received, the security module 324 will determine the user's 104 profile transfer permissions (step 860) and transfer the profile according to those permissions (step 864). This means that if a user 104 tries to transfer their profile 340 to another user 104 but the transferring user doesn't have the requisite permissions to perform such a transfer or the current situation dictates that such a transfer is not permitted (e.g., because the user device 108 is located outside of a particular zone or because the transferee user is not allowed to receive the profile from the transferring user), then the security module 324 will deny the user's 104 request to perform a profile transfer.

As can be appreciated, there are a number of ways in which a profile may be transferred from one user to another user. In some embodiments, the profile of one user device 108 may be transmitted in one or more data packets across a communication network 208 to another user device 108 along with instructions for reconstructing the profile from the data packets. In some embodiments, a direct link (e.g., USB, Bluetooth, infrared, etc.) may be established between the two user devices 108 and the profile may be copied and pasted according to known computing techniques. Once the profile transfer has been completed, assuming that such a process was permissible, the method returns to step 804.

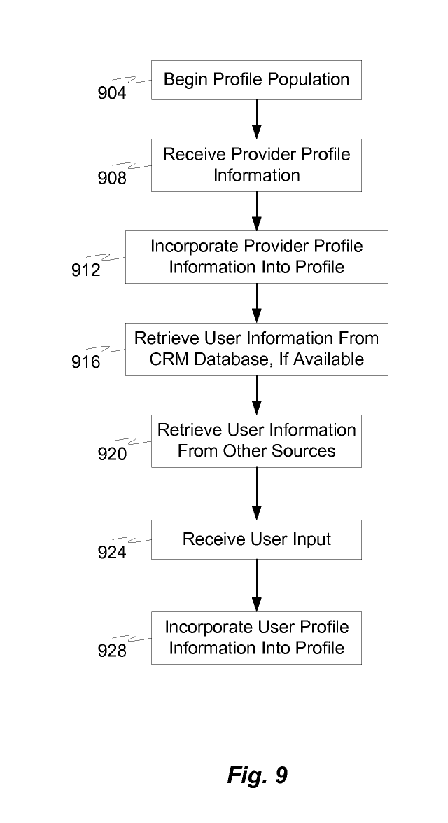

Referring now to FIG. 9, an exemplary profile population method will be described in accordance with at least some embodiments of the present invention. This particular process may be performed when a user 104 first checks into a hospitality vendor's resort or when the user 104 is first provided with the user device 108. The profile population process begins when a an administrative user or administrative software identifies the user 104, assigns the user device 108 to the user 104, and starts the profile population process (step 904). The profile population process initially starts by receiving the provider portion 348 of the profile 340 (step 908) and incorporating that information into the profile 340 of the user device 108 (step 912). This data may be generic for all users or generic to a specific type of user (e.g., VIP customers may receive one type of provider profile 348 whereas other customers may receive a different type of provider profile 348 with different rules and permissions).

After the provider portion 348 has been populated, any information known about the user 104 from the CRM database 244 is retrieved from the database 244 (step 916). In addition to receiving information from the CRM database 244, user information may also be received from other sources, such as publicly-available sources (step 920). Some examples of publicly-available sources include, without limitation, websites, social media websites, blogs, news feeds, and the like. In some embodiments, the information may be completely available to all of the public for viewing. In some embodiments, information about a user may be retrieved from a secured source if the necessary passwords to access such information are known to the entity populating the profile 340. For example, a user may provide or have already provided information regarding a particular social networking identity they use and may also have provided the hospitality vendor with a password to access their social networking website. While this website is not generally available to the public, the social network website is available to the hospitality vendor by virtue of the fact that the vendor knows the appropriate password.

Another source of user information may include any information received from the user 104 as user input (step 924). This user input may be received during the user check-in process, during the user device 108 check-out process, when the user booked their reservations with the hospitality vendor, or at any other point during a user interaction.

The user information received from the CRM database 244, other sources of information, and directly from the user 104 is then incorporated into the user portion 344 of the profile 340 and the profile population process is then completed (step 928). As can be appreciated, this process may be re-performed at any point in time where new information or changes to existing information in the profile 340 are received.

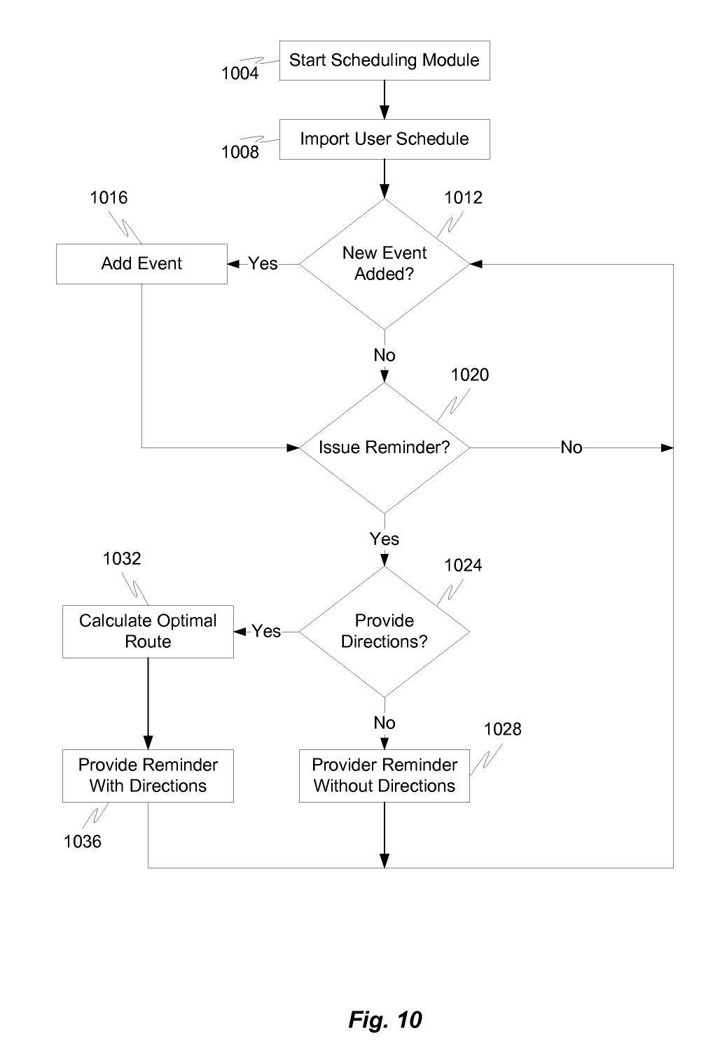

With reference now to FIG. 10, an exemplary scheduling method will be described in accordance with at least some embodiments of the present invention. The method is initiated when the scheduling module 332 is invoked (step 1004). As with other modules and applications described herein, the invocation of the scheduling module 332 may occur either manually or automatically.

Once invoked, the scheduling module 332 imports the user's 104 existing schedule, if such a schedule exists and is available (step 1008). This step may involve the scheduling module 332 receiving data from a user's 104 personal scheduling application, a user itinerary known to the hospitality vendor, or any other source of schedule information. In some embodiments, the scheduling module 332 may pull the necessary schedule information from a schedule source. In some embodiments, the source of schedule information may push the necessary schedule information to the scheduling module 332. Moreover, the importation of the user schedule may be an automated process, a manual process, or a combination of the two.

Once the user's schedule has been imported and made available to the scheduling module 332, the scheduling module 332 is capable of maintaining a personal schedule for the user 104. Thus, the method continues with the scheduling module 332 determining whether a new event has been added to the user's schedule (step 1012). If such an event has been added, then the scheduling module 332 adds the event to the schedule as necessary and associates any other useful information with the newly added event (step 1016).

After the new event has been added, or if no event has been added, then scheduling module 332 determines if a reminder should be issued (step 1020). This determination may simply be based on determining whether a scheduled event is set to occur in a predetermined amount of time (e.g., five minutes, ten minutes, fifteen minutes, etc.). However, this determination can be made more intelligent since the scheduling module 332 has access to user 104 presence information, user device 108 location information, and other types of information which can help create a more intelligent reminder. In particular, if the scheduling module 332 determines that a user 104 is currently located at a poker table (virtual or physical) and is in the middle of a hand, the scheduling module 332 can time its reminder to (i) minimize the disruption to the user 104 and (ii) ensure that the user 104 has adequate time to finish the hand and still make the scheduled event. As another example, the scheduling module 332 can determine a user device's 108 current location, approximate that location with the location of the user 104, the location where the event is set to start, and calculate an estimated travel time to determine whether and when a reminder should be issued. Thus, the time when a reminder is issued can vary based on a number of factors including, without limitation, a user's 104 current participation in an activity, the user's 104 presence information, the user device's 108 location information, the location of the event, the traffic between the location of the event and the user 104, the estimated travel time, environmental conditions, other intervening events (e.g., a reminder for two sequential events may be issued simultaneously), and the like.

If it is determined that a reminder is not to be issued, then the method returns to step 1012. Otherwise, the method continues with the scheduling module 332 determining whether it is also going to provide directions to the event along with the reminder (step 1024). If this query is answered negatively, then the reminder is provided to the user 104 via the user interface 356 without directions (step 1028). If the query of step 1024 is answered affirmatively, however, the method continues with the scheduling module 332 calculating an optimal route (step 1032) and incorporating that optimal route information in the reminder (step 1036). Thereafter, the method returns to step 1012.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of operating an application or module from a mobile user device, the method comprising:
receiving a user input at the user device;
determining that the user input corresponds to a command for controlling the application or module via the user device;
prior to executing the command, referencing profile information containing one or more rules which govern a user's utilization of the user device;
receiving at least one of user presence information and user device location information; and
based on the profile information and the at least one of user presence information and user device location information, determining whether to one of (i) restrict the command prior to controlling the application or module and (ii) execute the command without restriction.

2. The method of claim 1, wherein both user presence information and user device location information are considered in determining whether to one of (i) restrict the command prior to controlling the application or module and (ii) execute the command without restriction.

3. The method of claim 1, wherein the application or module comprises a gambling application, wherein the command for controlling the gambling application comprises placing a bet for money in a game of chance, and wherein the command is restricted when the user device location information indicates that the user device is outside an area of a predefined gambling zone.

4. The method of claim 1, wherein the application or module comprises a communication application, wherein the command for controlling the communication application comprises instructions for establishing a communication session with another user device, and wherein the command is restricted when the user presence information and user device location information indicates that the user is separated from the user device.

5. The method of claim 1, wherein the application or module comprises one or more of a security module, a scheduling module, and a hospitality module.

6. The method of claim 5, wherein the application or module comprises a security module and wherein the command for controlling the security module comprises at least one of (i) a request to access an asset; (ii) a request to process a transaction with an account; and (iii) a request to transfer at least some of the profile information to another user.

7. The method of claim 5, wherein the application or module comprises a hospitality module, wherein the command for controlling the hospitality module comprises receiving a request to receive a service or information about a service, and wherein the command is restricted based at least on the profile information.

8. The method of claim 5, wherein the application or module comprises a scheduling module, wherein the command for controlling the scheduling module comprises a user request to receive directions to an event along with a reminder for the event, and wherein the directions to the event are dynamically calculated based on the user device location information, the location of the event, and the estimated time to travel to the location of the event from the location corresponding to the user device location information.

9. The method of claim 8, wherein the timing with which the reminder is provided to the user is also based on the user device location information, the location of the event, and the estimated time to travel to the location of the event from the location corresponding to the user device location information.

10. The method of claim 1, further comprising:
determining that the user is experiencing an idle period;
identifying one or more suggested experiences for the user to engage in during the idle period, wherein the one or more suggested experiences for the user are selected based on an estimated duration of the idle period and an estimated time to complete the suggested experiences; and
presenting the one or more suggested experiences to the user via a user interface of the user device.

11. A computer readable medium having stored thereon instructions that cause a computing system to execute a method of operating an application or module from a mobile user device, the instructions comprising:
instructions configured to receive a command for controlling the application or module via the user device;
instructions configured to reference profile information containing one or more rules which govern a user's utilization of the user device;
instructions configured to receive and analyze at least one of user presence information and user device location information; and
instructions configured to, based on the profile information and the at least one of user presence information and user device location information, determine whether to one of (i) restrict the command prior to controlling the application or module and (ii) execute the command without restriction.

12. The computer readable medium of claim 11, wherein both user presence information and user device location information are considered in determining whether to one of (i) restrict the command prior to controlling the application or module and (ii) execute the command without restriction.

13. The computer readable medium of claim 11, wherein the application or module comprises a gambling application, wherein the command for controlling the gambling application comprises placing a bet for money in a game of chance, and wherein the command is restricted when the user device location information indicates that the user device is outside an area of a predefined gambling zone.

14. The computer readable medium of claim 11, wherein the application or module comprises a security module and wherein the command for controlling the security module comprises at least one of (i) a request to access an asset; (ii) a request to process a transaction with an account; and (iii) a request to transfer at least some of the profile information to another user.

15. The computer readable medium of claim 11, wherein the application or module comprises a hospitality module, wherein the command for controlling the hospitality module comprises receiving a request to receive a service or information about a service, and wherein the command is restricted based at least on the profile information.

16. The computer readable medium of claim 11, wherein the application or module comprises a scheduling module, wherein the command for controlling the scheduling module comprises a user request to receive directions to an event along with a reminder for the event, wherein the directions to the event are dynamically calculated based on the user device location information, the location of the event, and the estimated time to travel to the location of the event from the location corresponding to the user device location information, and wherein the timing with which the reminder is provided to the user is also based on the user device location information, the location of the event, and the estimated time to travel to the location of the event from the location corresponding to the user device location information.

17. The computer readable medium of claim 11, the instructions further comprising:
instructions configured to determine that the user is experiencing an idle period;
instructions configured to identify one or more suggested experiences for the user to engage in during the idle period, wherein the one or more suggested experiences for the user are selected based on an estimated duration of the idle period and an estimated time to complete the suggested experiences; and
instructions configured to present the one or more suggested experiences to the user via a user interface of the user device.

18. A communication system comprising:
a mobile user device comprising the ability to control operations of an application or module, the mobile user device including a feature restrictor that is configured to receive a command for controlling an application or module via the user device, reference profile information containing one or more rules which govern a user's utilization of the user device, receive and analyze at least one of user presence information and user device location information, and, based on the profile information and the at least one of user presence information and user device location information, determine whether to one of (i) restrict the command prior to controlling the application or module and (ii) execute the command without restriction.

19. The communication system of claim 18, wherein the application or module controlled by the user device resides on the user device.

20. The communication system of claim 18, wherein the profile information containing one or more rules is at least partially maintained on a server and provided to the user device on an as-needed basis.
